(19) United States
(12) Patent Application Publication
(10) Pub. No.: US 2025/0368019 A1
(43) Pub. Date: Dec. 4, 2025

(54) Broken Vehicle Window Cover Device

(71) Applicant: Alexus Best, Orlando, FL (US)

(72) Inventor: Alexus Best, Orlando, FL (US)

(21) Appl. No.: 19/219,111

(22) Filed: May 27, 2025

Related U.S. Application Data
(60) Provisional application No. 63/654,155, filed on May 31, 2024.

(51) Int. Cl. B60J 11/08; B60J 3/06; B60R 16/033

(52) U.S. Cl. CPC B60J 11/08; B60R 16/033; B60J 3/06

(57) ABSTRACT

A broken vehicle window cover device is provided. The device serves as a temporary replacement for a damaged or missing vehicle window while offering enhanced security, visibility, and weather resistance. The device comprises a sleeve that wraps around the window frame, ensuring a tight seal using an elastic lining, and may include a removable insert made of impact-resistant polycarbonate with optional tinting, UV protection, and airflow control features. A wireless communication module connects to a mobile application, integrating tamper detection sensors, a camera for live streaming, and a two-way speaker for remote communication and alarms.

### CROSS-REFERENCE TO RELATED APPLICATION

The present application claims priority to, and the benefit of, U.S. Provisional Application No. 63/654,155, which was filed on May 31, 2024, and is incorporated herein by reference in its entirety.

### FIELD OF THE INVENTION

The present invention relates generally to the field of vehicle window coverings. More specifically, the present invention relates to a device that serves as a temporary replacement for a damaged or missing vehicle window and is comprised of a weather-resistant sleeve with an optional impact-resistant insert offering tinting, UV protection, and airflow control. A wireless communication module further connects to a mobile application, integrating tamper detection sensors, a live-streaming camera, and a two-way speaker for remote monitoring and security. Accordingly, the present disclosure makes specific reference thereto. Nonetheless, it is to be appreciated that aspects of the present invention are also equally applicable to other like applications, devices, and methods of manufacture.

### BACKGROUND

When a vehicle window breaks, the vehicle owner may face immediate challenges related to the safety, security, and aesthetics of the vehicle. More specifically, a broken window exposes the vehicle's interior to weather conditions such as rain and wind, making driving or even parking outdoors problematic. Vehicle owners who cannot afford immediate repairs often resort to makeshift solutions such as plastic sheets, trash bags, or duct tape to cover the opening. However, these temporary fixes are typically ineffective, providing minimal protection against water, wind, and debris. Additionally, such coverings detract from the vehicle's appearance and may cause embarrassment for the owner. More critically, these solutions pose security risks, as they can be easily breached by potential thieves, increasing the likelihood of vehicle break-ins or theft. The lack of a secure and visually acceptable temporary window cover leaves vehicle owners with limited options while awaiting a permanent repair.

Therefore, there exists a long-felt need in the art for a broken vehicle window cover device that provides a secure and weather-resistant temporary barrier for a broken vehicle window while maintaining full visibility. There also exists a long-felt need in the art for a broken vehicle window cover device that enhances vehicle security by offering a strong, tamper-resistant structure that prevents unauthorized access. Moreover, there exists a long-felt need in the art for a broken vehicle window cover device that integrates smart technology to alert the owner of any tampering while ensuring convenient and sustainable operation.

The subject matter disclosed and claimed herein, in one embodiment thereof, comprises a broken vehicle window cover device. The device serves as a temporary replacement for a damaged or missing vehicle window while offering enhanced security, visibility, and weather resistance. The device comprises a sleeve that wraps around the window frame, ensuring a tight seal using an elastic lining, and may include a removable insert made of impact-resistant polycarbonate with optional tinting, UV protection, and airflow control features. A wireless communication module connects to a mobile application, integrating tamper detection sensors, a camera for live streaming, and a two-way speaker for remote communication and alarms.

In this manner, the broken vehicle window cover device of the present invention accomplishes all the foregoing objectives and provides a device that fits securely over a broken vehicle window. More specifically, the device ensures weather resistance and visibility through a dual-layer plastic structure with an elastic perimeter for a firm seal. The inclusion of a removable, semi-rigid insert enhances durability and security while allowing controlled ventilation through airflow gills. Additionally, the device incorporates smart technology, including a wireless communication module, tamper sensors, and a mobile app integration, enabling real-time alerts in case of unauthorized access. A built-in camera, two-way speaker, and alarm system further enhance security and deterrence. By combining security, convenience, and an aesthetically pleasing design, the broken vehicle window cover device provides an effective temporary solution for vehicle owners awaiting permanent window repairs.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a broken vehicle window cover device. The broken vehicle window cover device is a protective cover designed to serve as a temporary replacement for a damaged or missing vehicle window that provides a secure, weather-resistant, and aesthetically pleasing alternative that maintains visibility while offering enhanced durability and functionality.

In a first embodiment, the device is comprised of a sleeve that wraps around the entire window frame, ensuring a tight, weatherproof seal around the frame that is preferably made from a dual-ply transparent plastic material that provides impact resistance while maintaining visibility. The perimeter of the sleeve is comprised of an elastic lining that securely grips the window frame to prevent flapping, sagging, or displacement during use.

In a second embodiment, the sleeve is comprised of a removable insert, which is preferably a semi-rigid, transparent insert. The insert is secured within the sleeve using a fastener system and may be comprised of a multi-layer polycarbonate material that provides enhanced impact resistance. In one embodiment, the insert is comprised of at least one airflow gill to allow for controlled ventilation, reducing condensation inside the vehicle while improving overall comfort. In one embodiment, the insert is interchangeable, allowing the user to replace it with different insert options such as UV-coated, tinted, or polarized variations based on their preferences and environmental conditions.

To provide an additional layer of security, the device is comprised of a wireless communication module that connects to a mobile application. The device may also be comprised of tamper detection sensors that produce an alert in the form of a notification, text, call, etc., from the application if any attempt is made to remove or disturb the device. The device may also be comprised of at least one camera that records and streams live video and/or photos to the mobile application. In one embodiment, the camera begins capturing photo and video when the sensor detects a breach. To enhance deterrence, the device may be comprised of a two-way speaker that allows the user to communicate remotely with individuals near the device. The speaker may also be comprised of a microphone to enable two-way audio communication through the mobile application. Additionally, the speaker may emit an alarm upon detecting a breach of the device, producing a loud noise to discourage theft and unauthorized access.

All electrical components of the device may be powered by a power source, such as, but not limited to, a solar panel, a battery, or a combination thereof. In one embodiment, the power source is comprised of a solar panel that continuously recharges an internal battery, ensuring extended operation without requiring manual charging.

Accordingly, the broken vehicle window cover device of the present invention is particularly advantageous as it provides a device that fits securely over a broken vehicle window. More specifically, the device ensures weather resistance and visibility through a dual-layer plastic structure with an elastic perimeter for a firm seal. The inclusion of a removable, semi-rigid insert enhances durability and security while allowing controlled ventilation through airflow gills. Additionally, the device incorporates smart technology, including a wireless communication module, tamper sensors, and a mobile app integration, enabling real-time alerts in case of unauthorized access. A built-in camera, two-way speaker, and alarm system further enhance security and deterrence. By combining security, convenience, and an aesthetically pleasing design, the broken vehicle window cover device provides an effective temporary solution for vehicle owners awaiting permanent window repairs. In this manner, the broken vehicle window cover device overcomes the limitations of existing methods and devices used for temporary broken vehicle window coverings known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a broken vehicle window cover device of the present invention in accordance with the disclosed architecture;

FIG. 2 illustrates a side view of one potential embodiment of a broken vehicle window cover device of the present invention while attached over a vehicle window in accordance with the disclosed architecture;

FIG. 3 illustrates a block diagram of functions of a mobile application of one potential embodiment of a broken vehicle window cover device of the present invention in accordance with the disclosed architecture; and

FIG. 4 illustrates a perspective view of one potential embodiment of a broken vehicle window cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a broken vehicle window cover device that provides a secure and weather-resistant temporary barrier for a broken vehicle window while maintaining full visibility. There also exists a long-felt need in the art for a broken vehicle window cover device that enhances vehicle security by offering a strong, tamper-resistant structure that prevents unauthorized access. Moreover, there exists a long-felt need in the art for a broken vehicle window cover device that integrates smart technology to alert the owner of any tampering while ensuring convenient and sustainable operation.

The present invention, in one exemplary embodiment, is comprised of a broken vehicle window cover device. The broken vehicle window cover device serves as a temporary replacement for a damaged or missing vehicle window, offering a secure, weather-resistant, and aesthetically pleasing solution that maintains visibility while providing enhanced durability and functionality.

In a first embodiment, the device comprises a sleeve that wraps around the entire window frame, creating a tight, weatherproof seal. The sleeve is preferably made from a dual-ply transparent plastic material that ensures impact resistance while maintaining visibility. An elastic lining along the perimeter securely grips the window frame, preventing flapping, sagging, or displacement during use.

In a second embodiment, the sleeve includes a removable insert, preferably a semi-rigid, transparent component secured using a fastener system. The insert may be made of a multi-layer polycarbonate material for enhanced impact resistance. In one embodiment, the insert features at least one airflow gill to allow controlled ventilation, reducing condensation and improving interior comfort. The insert may also be interchangeable, allowing customization with UV-coated, tinted, or polarized variations based on user preference and environmental conditions

For added security, the device incorporates a wireless communication module that connects to a mobile application. Tamper detection sensors generate alerts via notifications, text messages, or calls when unauthorized removal or disturbance occurs. A built-in camera may capture and stream live video or photos to the mobile application, activating upon sensor detection of a breach. To further enhance deterrence, the device may include a two-way speaker that enables remote communication with individuals near the device. The speaker may also function as a microphone for two-way audio communication and can emit a loud alarm upon detecting unauthorized access.

All electrical components may be powered by a power source, such as a solar panel, a battery, or a combination of both. In one embodiment, a solar panel continuously recharges an internal battery, ensuring extended operation without manual charging.

As a result, the broken vehicle window cover device provides a secure, weather-resistant solution for broken vehicle windows. The dual-layer plastic structure with an elastic perimeter ensures a firm seal, while a removable, semi-rigid insert enhances durability and allows controlled ventilation. Smart technology features, including a wireless communication module, tamper sensors, mobile app integration, a built-in camera, a two-way speaker, and an alarm system, enhance security and deterrence. By combining security, convenience, and an aesthetically pleasing design, the device serves as an effective temporary solution for vehicle owners awaiting permanent window repairs, addressing limitations found in existing temporary coverings.

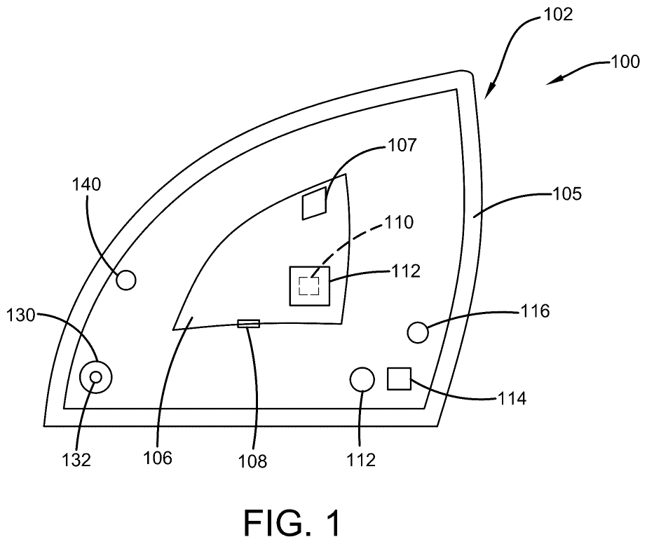

Referring initially to the drawings, FIG. 1 illustrates a side view of one potential embodiment of a broken vehicle window cover device 100 of the present invention in accordance with the disclosed architecture. The broken vehicle window cover device 100 is a protective cover designed to serve as a temporary replacement for a damaged or missing vehicle window. Unlike conventional makeshift solutions such as plastic bags, duct tape, or cardboard, the device 100 provides a secure, weather-resistant, and aesthetically pleasing alternative that maintains visibility while offering enhanced durability and functionality.

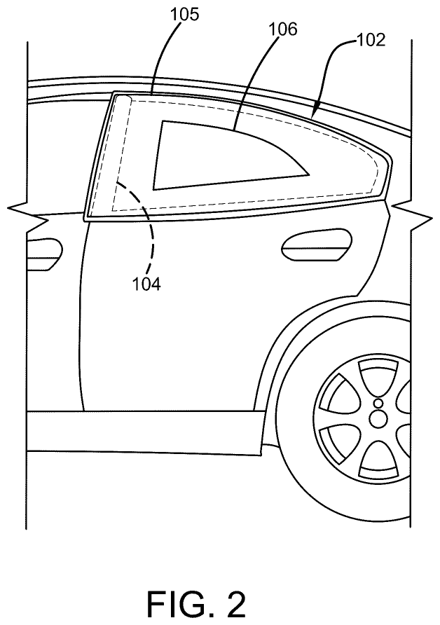

In a first embodiment, the device 100 is comprised of a sleeve 102 that wraps around the entire window frame 104, as seen in FIG. 2, ensuring a tight, weatherproof seal around the frame 104. The sleeve 102 is preferably made from a dual-ply transparent plastic material that provides impact resistance while maintaining visibility. The perimeter of the sleeve 102 is comprised of an elastic lining 105 that securely grips the window frame 104 to prevent flapping, sagging, or displacement during use. By creating a firm seal, the device 100 improves the vehicle's energy efficiency by preventing air leaks, thereby allowing the heating and air conditioning system to function optimally. To accommodate privacy preferences, the sleeve 102 may be tinted in one embodiment.

In a second embodiment, the sleeve 102 is comprised of a removable insert 106 (as seen in FIG. 1 and FIG. 2), which is preferably a semi-rigid, transparent insert. The insert 106 is secured within the sleeve 102 using a fastener system 108 such as, but not limited to, a zipper, a hook-and-loop fastener, a magnetic seal, etc. The insert 106 may be comprised of a multi-layer polycarbonate material that provides enhanced impact resistance, making it more difficult for unauthorized individuals to force entry. In one embodiment, the insert 106 is comprised of at least one airflow gill 110 to allow for controlled ventilation, reducing condensation inside the vehicle while improving overall comfort. The gill 110 may be covered with at least one cover 112 (as seen in FIG. 1) to block airflow when needed. In different embodiments, the insert 106 may be a tinted and/or polarized insert to reduce glare and improve privacy. In a further embodiment, the insert 106 is comprised of a UV-coating 107 that protects the interior of the vehicle from sun damage and prevents the fading of upholstery and dashboard materials. In another embodiment, the insert 106 is interchangeable, allowing the user to replace it with different insert 106 options such as UV-coated, tinted, or polarized variations based on their preferences and environmental conditions.

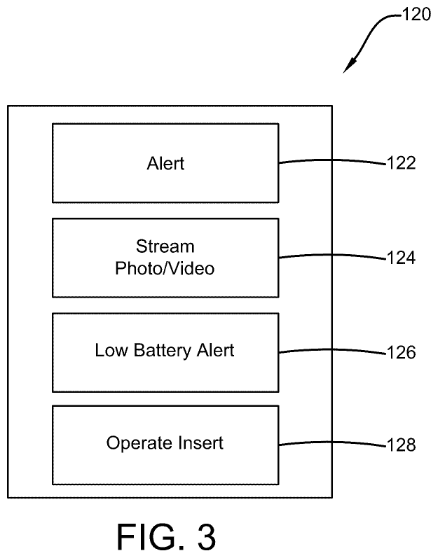

To provide an additional layer of security, the device 100 is comprised of a wireless communication module 113 that connects to a mobile application 120. The device 100 may also be comprised of tamper detection sensors 114 such as, but not limited to, a motion sensor, an impact sensor, a vibration sensor, etc., that produces an alert 122 in the form of a notification, text, call, etc., from the application 120 if any attempt is made to remove or disturb the device 100, as seen in FIG. 3.

The device 100 may also be comprised of at least one camera 116 that records and streams live video and/or photos 124 to the mobile application 120. In one embodiment, the camera 116 begins capturing photo and video when the sensor 114 detects a breach. To enhance deterrence, the device 100 may be comprised of a two-way speaker 130 that allows the user to communicate remotely with individuals near the device 100. The speaker 130 may also be comprised of a microphone 132 to enable two-way audio communication through the mobile application 120. Additionally, the speaker 130 may emit an alarm upon detecting a breach of the device 100, producing a loud noise to discourage theft and unauthorized access. In a further embodiment, the alarm may have adjustable volume settings, allowing the user to customize the intensity of the deterrent sound.

All electrical components of the device 100 may be powered by a power source 140, such as, but not limited to, a solar panel, a battery, or a combination thereof. In one embodiment, the power source 140 is comprised of a solar panel that continuously recharges an internal battery, ensuring extended operation without requiring manual charging. In another embodiment, the device 100 may include a low-battery alert 126 wherein the mobile application 120 notifies the user when the battery requires recharging or replacement via a notification, a text, an email, a call, etc., as seen in FIG. 3.

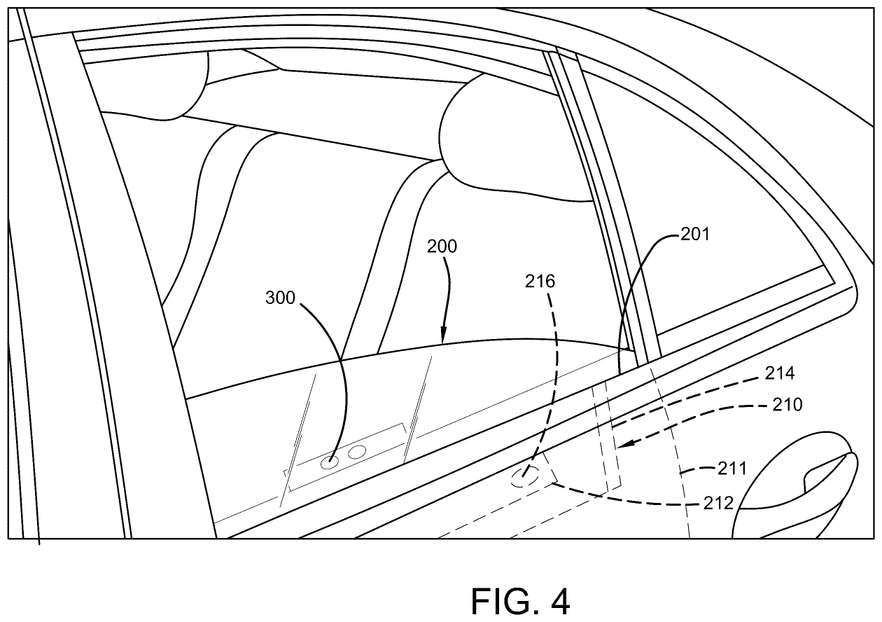

An alternative embodiment of the device 100 may be comprised of a transparent (preferably but not limited to plexiglass) insert 200 configured to fit within the vehicle's existing window channel 201, as seen in FIG. 4. The insert 200 may be shaped to conform to standard automotive window geometries and may include a UV-coating 107 and may be tinted.

The insert 200 may be supported and moved by a motorized apparatus 210 configured to reside within the vehicle door cavity 211, occupying the same structural region as a standard vehicle window regulator. The motorized apparatus 210 may include structures such as but not limited to a drive motor 212, guide rails 214, and position sensors 216 for accurate movement control. The motorized apparatus 210 may be operable 128 via existing vehicle window control switches 300 as well as through the mobile application 120. This configuration enables remote raising and lowering of the insert 200.

All previously described features of the device 100, including the camera module 140, microphone 180, and wireless transmission unit 150, may be incorporated into or affixed to the insert 200. The integration of these components into the rigid plexiglass insert 200 provides enhanced durability and increased security while maintaining full functionality of the monitoring and control systems.

Therefore, the broken vehicle window cover device 100 represents an advanced and practical solution for drivers in need of a temporary window replacement. By combining clear visibility, high security, weather resistance, and smart technology, the device 100 eliminates the inconvenience and unattractive appearance of traditional temporary vehicle window fixes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “broken vehicle window cover device” and “device” are interchangeable and refer to the broken vehicle window cover device 100 of the present invention.

Notwithstanding the foregoing, the broken vehicle window cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the broken vehicle window cover device 100 as shown in the FIGS. are for illustrative purposes only, and that many other sizes and shapes of the broken vehicle window cover device 100 are well within the scope of the present disclosure. Although the dimensions of the broken vehicle window cover device 100 are important design parameters for user convenience, the broken vehicle window cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A broken vehicle window cover device comprising:
a sleeve comprised of a transparent plastic material; and
an elastic lining disposed along a perimeter of the sleeve, the elastic lining configured to grip a vehicle window frame to prevent displacement of the sleeve.

2. The broken vehicle window cover device of claim 1, wherein the transparent plastic material is comprised of a dual-ply material.

3. The broken vehicle window cover device of claim 2, wherein the dual-ply material is comprised of an impact resistant material.

4. A broken vehicle window cover device comprising:
a sleeve comprised of a transparent plastic material;
a removable insert secured within the sleeve using a fastener system; and
an elastic lining disposed along a perimeter of the sleeve, the elastic lining configured to grip a vehicle window frame to prevent displacement of the sleeve.

5. The broken vehicle window cover device of claim 4, wherein the fastening system is comprised of a zipper, a hook and loop fastener, or a magnetic seal.

6. The broken vehicle window cover device of claim 4, wherein the removable insert is removably attached to the sleeve via the fastener system.

7. The broken vehicle window cover device of claim 4, wherein the removable insert is comprised of a tinted insert.

8. The broken vehicle window cover device of claim 4, wherein the removable insert is comprised of a polarized insert.

9. The broken vehicle window cover device of claim 4, wherein the removable insert is comprised of a UV-coating.

10. A broken vehicle window cover device comprising:
a sleeve comprised of a transparent plastic material;
a removable insert secured within the sleeve using a fastener system, the removable insert comprised of an airflow gill; and
an elastic lining disposed along a perimeter of the sleeve, the elastic lining configured to grip a vehicle window frame to prevent displacement of the sleeve.

11. The broken vehicle window cover device of claim 10 further comprised of a wireless communication module.

12. The broken vehicle window cover device of claim 10 further comprised of a tamper detection sensor comprised of a motion sensor, an impact sensor, or a vibration sensor.

13. The broken vehicle window cover device of claim 10 further comprised of a camera.

14. The broken vehicle window cover device of claim 10 further comprised of a two-way speaker.

15. The broken vehicle window cover device of claim 10 further comprised of a power source.

16. The broken vehicle window cover device of claim 15, wherein the power source is comprised of a battery.

17. The broken vehicle window cover device of claim 15, wherein the power source is comprised of a solar panel.

18. The broken vehicle window cover device of claim 10 further comprised of a microphone.

19. The broken vehicle window cover device of claim 18, wherein the microphone is comprised of a two-way microphone.

20. The broken vehicle window cover device of claim 10 further comprised of a mobile application that produces an alert based on an input from the tamper detection sensor.
